(19) United States
(12) Patent Application Publication
(10) Pub. No.: US 2008/0170636 A1
(43) Pub. Date: Jul. 17, 2008

(54) APPARATUS AND METHOD FOR REDUCING PEAK-TO-AVERAGE POWER RATIO IN A WIRELESS COMMUNICATION SYSTEM

(75) Inventor: Seung-Hee HAN, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/844,582

(22) Filed: Aug. 24, 2007

(30) Foreign Application Priority Data
Jan. 17, 2007 (KR) 2007-5017

(51) Int. Cl. H04J 11/00; H04L 27/28

(52) U.S. Cl. 375/261; 375/260

(57) ABSTRACT

An apparatus and method for reducing PAPR in a wireless communication system are provided, in which an encoder encodes a transmission signal in a predetermined coding scheme, a modulator modulates the coded transmission signal by mapping each symbol of the coded transmission signal to one HEX constellation point selected from at least one HEX constellation point available for mapping to the each transmission symbol, an IFFT processor converts the modulated transmission signal to a time signal by IFFT, and an RF processor converts the time signal to an RF signal and transmits the RF signal to a receiver through an antenna.

### PRIORITY

This application claims priority under 35 U.S.C. § 119 to an application filed in the Korean Intellectual Property Office on Jan. 17, 2007 and assigned Serial No. 2007-5017, the contents of which are incorporated herein by reference.

### BACKGROUND OF THE INVENTION

1. Field of the Invention

The present invention relates generally to a wireless communication system, and in particular, to an apparatus and method for reducing Peak-to-Average Power Ratio (PAPR) in a wireless communication system.

2. Description of the Related Art

The use of a multi-carrier modulation scheme such as Orthogonal Frequency Division Multiplexing (OFDM) offers the benefits of a high frequency efficiency and robustness against multipath fading channels in a wireless communication system. Thus, an efficient transmitter and receiver can be configured.

A shortcoming with OFDM, however, is high PAPR. For example, the OFDM transmitter transmits a signal given as

$$x ( t ) = \frac{1}{\sqrt{N}} {\sum }_{n = 0}^{N - 1} {X}_{n} {e}^{j2π {f}_{n} t} , 0 \leq t \leq NT \qquad ( 1 )$$

where x(t) denotes the transmission signal, N denotes the number of subcarriers, Xₙ denotes an n^{th} transmission symbol, fₙ denotes an n^{th} subcarrier, and NT denotes the length of an OFDM block.

The PAPR of the transmission signal x(t) is computed by

$$PAPR = \frac{{max}_{0 \leq t < NT} {\vert x ( t ) \vert}^{2}}{\frac{1}{NT} \cdot {\int }_{0}^{NT} {\vert x ( t ) \vert}^{2}} \qquad ( 2 )$$

where NT denotes the length of an OFDM block and x(t) denotes the transmission signal.

As described in Equation (2), the PAPR is the ratio of the peak power to average power of the transmission signal.

In the OFDM wireless communication system, a high PAPR decreases the power efficiency of a transmission amplifier and leads the transmission amplifier into a non-linear region, resulting in inter-modulation among subcarriers and out-of-band radiation.

### SUMMARY OF THE INVENTION

An aspect of the present invention is to substantially solve at least the above problems and/or disadvantages and to provide at least the advantages below. Accordingly, an aspect of the present invention is to provide an apparatus and method for reducing PAPR in a wireless communication system.

Another aspect of the present invention is to provide an apparatus and method for reducing PAPR by mapping modulation symbols of a transmission signal to other modulation symbols designed to have an average power equal to or lower than that of the transmission modulation symbols in a wireless communication system.

A further aspect of the present invention is to provide an apparatus and method for reducing PAPR by mapping one symbol to one constellation point selected from one or more constellation points available for the symbol in a HEXagonal (HEX) modulation scheme in a wireless communication system.

Still another aspect of the present invention is to provide an apparatus and method for reducing PAPR by mapping Quadrature Amplitude Modulation (QAM) modulation symbols to HEX modulation symbols in a wireless communication system.

According to an aspect of the present invention, there is provided a transmitter in an OFDM wireless communication system, in which an encoder encodes a transmission signal in a predetermined coding scheme and outputs a coded transmission signal, a modulator modulates the coded transmission signal by mapping each symbol of the coded transmission signal to a HEX constellation point being a constellation point of a HEX modulation scheme selected from at least one HEX constellation point available for mapping to the each transmission symbol, and outputs a modulated transmission signal, an IFFT processor converts the modulated transmission signal to a time signal by IFFT, and an RF processor converts the time signal to an RF signal and transmits the RF signal to a receiver through an antenna.

According to another aspect of the present invention, there is provided a transmission method in an OFDM wireless communication system, in which a transmission signal is encoded in a predetermined coding scheme, the coded transmission signal is modulated by mapping each symbol of the coded transmission signal to a HEX constellation point being a constellation point of a HEX modulation scheme selected from at least one HEX constellation point available for mapping to the each transmission symbol, the modulated transmission signal is converted to a time signal by IFFT, and the time signal is converted to an RF signal and transmitted through an antenna.

According to a further aspect of the present invention, there is provided a transmitter in an OFDM wireless communication system, in which an encoder encodes a transmission signal in a predetermined coding scheme and outputs a coded transmission signal, a modulator modulates the coded transmission signal in a QAM modulation scheme and outputs QAM modulation symbols, a symbol mapper maps each of the QAM modulation symbols to a HEX constellation point being a constellation point of a HEX modulation scheme selected from at least one HEX constellation point available for mapping to the each QAM modulation symbol and outputs a mapped transmission signal, an IFFT processor converts the mapped transmission signal to a time signal by IFFT, and an RF processor converts the time signal to an RF signal and transmits the RF signal to a receiver through an antenna.

According to still another aspect of the present invention, there is provided a receiver in an OFDM wireless communication system, in which a receiving part receives a signal from a transmitter, an FFT processor converts the received signal to a frequency signal by FFT, a subcarrier demapper extracts HEX modulation symbols being modulation symbols of a HEX modulation scheme from subcarriers of the frequency signal, and a symbol demapper demaps QAM modulation symbols from the HEX modulation symbols.

According to yet another aspect of the present invention, there is provided a transmission method in an OFDM wireless communication system, in which a transmission signal is encoded in a predetermined coding scheme, the coded transmission signal is modulated in a QAM modulation scheme, each of the QAM modulation symbols is mapped to a HEX constellation point being a HEX constellation point of a HEX modulation scheme selected from at least one HEX constellation point available for mapping to the each QAM modulation symbol, the mapped transmission signal is converted to a time signal by IFFT, and the time signal is converted to an RF signal and transmitted to a receiver through an antenna.

According to yet further aspect of the present invention, there is provided a reception method in an OFDM wireless communication system, in which a signal is received from a transmitter and converted to a frequency signal by FFT, HEX modulation symbols being modulation symbols of a HEX modulation scheme are extracted from subcarriers of the frequency signal, and QAM modulation symbols are demapped from the HEX modulation symbols.

### BRIEF DESCRIPTION OF THE DRAWINGS

The above and other objects, features and advantages of the present invention will become more apparent from the following detailed description when taken in conjunction with the accompanying drawings in which:

FIGS. 1A, 1B and 1C. illustrate QAM constellation points, and HEX constellation points designed for PAPR reduction according to an embodiment of the present invention;

FIG. 2 is a block diagram of a transmitter in a wireless communication system according to the present invention;

FIG. 3 is a block diagram of a receiver in the wireless communication system according to the present invention;

FIG. 4 is a flowchart illustrating a transmission operation for PAPR reduction according to an embodiment of the present invention;

FIG. 5 is a flowchart illustrating an operation for detecting HEX modulation symbols for PAPR reduction according to an embodiment of the present invention;

FIG. 6 is a flowchart illustrating an operation for detecting HEX modulation symbols for PAPR reduction according to another embodiment of the present invention;

FIG. 7 is a flowchart illustrating a reception operation for PAPR reduction according to an embodiment of the present invention; and

FIG. 8 is a graph illustrating PAPR reduction according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a technique for reducing PAPR by use of a modulation scheme in a wireless communication system. In accordance with the present invention, the PAPR is reduced by corresponding each of modulation symbols of a first modulation scheme to a plurality of constellation points of a second modulation scheme, selecting one of the constellation points for the each modulation symbol, and mapping the each modulation symbol to the selected constellation point. The constellation points of the second modulation scheme are designed such that a transmission signal of the second modulation scheme has an average power equal to or lower than that of a transmission signal of the first modulation scheme.

While the following description is made in the context of an OFDM wireless communication system, it is to be clearly understood that the present invention is also applicable to wireless communication systems using other multi-carrier modulation schemes.

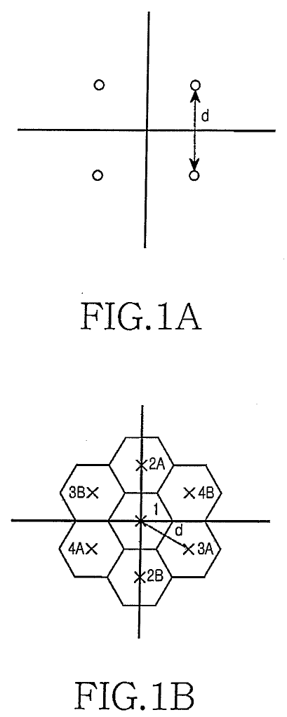

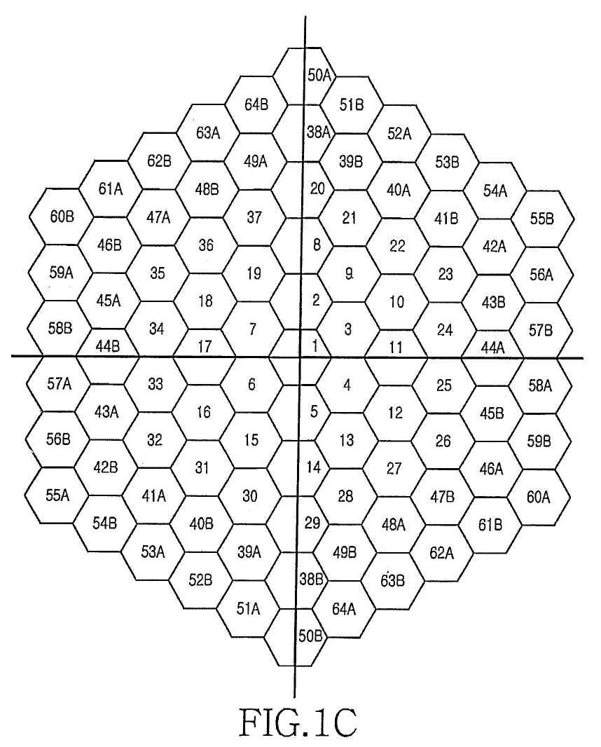

A description will be made below of a technique for reducing the PAPR of a QAM signal in the wireless communication system. For the PAPR reduction, QAM modulation symbols are mapped to constellation points of a HEX modulation scheme. The HEX constellation points are designed so that the average power of a HEX signal is equal to or lower than that of a QAM signal, as illustrated in FIGS. 1A, 1B and 1C.

FIGS. 1A, 1B and 1C illustrate QAM constellation points, and HEX constellation points designed for PAPR reduction according to an embodiment of the present invention. FIG. 1A illustrates constellation points of 4-QAM, FIG. 1B illustrates constellation points of 7-HEX, and FIG. 1C illustrates constellation points of 91-HEX.

As illustrated in FIG. 1B, 7-HEX is designed so that the distance between 7-HEX constellation points is at least equal to that between 4-QAM constellation points illustrated in FIG. 1A. Particularly, the distance between 7-HEX constellation points is at least equal to the shortest distance that can be possibly obtained between 4-QAM constellation points. Another 7-HEX design condition is that the average power of a 7-HEX signal is equal to or lower than that of a 4-QAM signal.

For instance, the size of a decision area in the 7-HEX modulation scheme is given by

$${v}_{H} = \frac{\sqrt{3}}{2} {d}^{2} \qquad ( 3 )$$

where VH denotes the size of a 7-HEX decision area and d denotes the distance between constellation points.

Equation (3) reveals that 7-HEX has a smaller decision area than that (d²) of 4-QAM. For a given area, therefore, more constellation points exist in 7-HEX in 4-QAM. This means that a QAM constellation point can correspond to a plurality of HEX constellation points, that is, a plurality of HEX constellation points are available for mapping to a QAM constellation point. The ratio between the number of HEX constellation points and the number of QAM constellation points is determined, for example, by the following equation.

$$\frac{\frac{1}{{v}_{H}}}{\frac{1}{{v}_{S}}} = \frac{{d}^{2}}{\frac{\sqrt{3}}{2} {d}^{2}} = \frac{2}{\sqrt{3}} \qquad ( 4 )$$

where v_{H} denotes the 7-HEX decision area size, v_{S} denotes the 4-QAM decision area size, and d denotes the distance between constellation points. If the distance between Q AM constellation points is d, the QAM decision area size is d².

As noted from Equation (4), 7-HEX has more constellation points than 4-QAM in the same area. When the 4-QAM constellation points illustrated in FIG. 1A are mapped, in a one-to-one correspondence, to the 7-HEX constellation points illustrated in FIG. 1B, three 7-HEX constellation points remain. Hence, each of some 4-QAM constellation points can correspond to one or more 7-HEX constellation points. For example, if a first 4-QAM constellation point corresponds to a first 7-HEX constellation point, for mapping, then, two 7-HEX constellation points are available for each of second, third and fourth 4-QAM constellation points.

To reduce the PAPR of QAM modulation symbols in the wireless communication system, a transmitter maps the QAM modulation symbols to HEX constellation points that can reduce the PAPR among available HEX constellation points. HEX constellation points available for mapping to one QAM modulation symbol have the same amplitude so that any choice of the HEX constellation points for the QAM modulation symbol does not change the average power of the transmission signal. For example, 7-HEX constellation points, 2A and 2B, available for a second 4-QAM modulation symbol have opposite phases but the same amplitude.

Referring to FIG. 1. C, 64-QAM constellation points can be mapped to 91-HEX constellation points. For example, 34 64-QAM constellation points correspond to 34 91-HEX constellation points in a one-to-one correspondence. Then, two 91-HEX constellation points are available in mapping for each of the remaining 27 64-QAM constellation points. The two 91-HEX constellation points have the same amplitude.

In the wireless communication system, a 64-QAM signal is 10.50 d² and a 91-HEX signal is 10.36 d² in average power, which means that the mapping between 64-QAM and 91-HEX does not increase the average power.

While the above embodiment of the present invention has been described in the context of 4-QAM and 64-QAM, by way of example, the effect of PAPR reduction can also be achieved by mapping constellation points of other QAM modulation schemes to HEX constellation points. For instance, 16-QAM constellation points can be mapped to 19-HEX constellation points.

While one QAM modulation symbol is mapped to a HEX constellation point selected from two available HEX constellation points in the above embodiment of the present invention, it can further be contemplated as another embodiment that one QAM modulation symbol is mapped to a HEX constellation point selected from two or more available HEX constellation points.

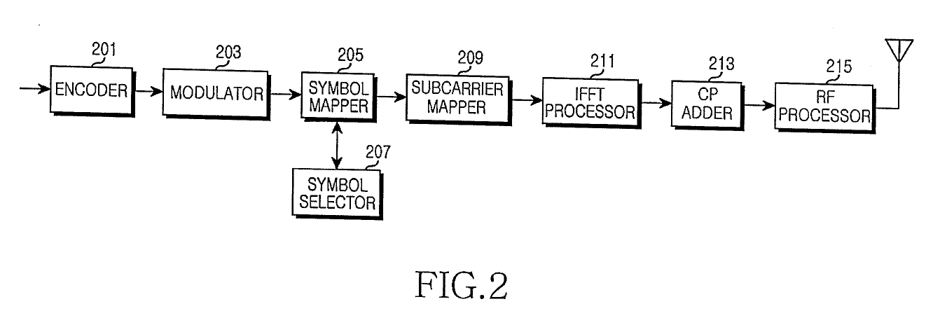

FIG. 2 is a block diagram of a transmitter in a wireless communication system according to the present invention.

Referring to FIG. 2, the transmitter includes an encoder 201, a modulator 203, a symbol mapper 205, a symbol selector 207, a subcarrier mapper 209, an Inverse Fast Fourier Transform (IFFT) processor 211, a Cyclic Prefix (CP) adder 213, and a Radio Frequency (RF) processor 215.

The encoder 201 encodes an information bit stream of a transmission signal received from an upper layer in a predetermined coding scheme (e.g. a Modulation and Coding Scheme (MCS) level).

The modulator 203 modulates the code symbols received from the encoder 201 according to the MCS level, thus creating complex symbols. For example, the modulator 203 modulates the code symbols in 4-QAM illustrated in FIG. 1A.

The symbol mapper 205 maps the modulation symbols received from the modulator 203 to HEX constellation points received from the symbol selector 207.

The symbol selector 207 selects the HEX constellation points for the modulation symbols and provides them to the symbol mapper 205. Specifically, the symbol selector 207 selects HEX constellation points with the lowest PAPR for the modulation symbols from among HEX constellation points available for the modulation symbols. For example, in FIGS. 1a and 1B, for the second 4-QAM constellation point, the symbol selector 207 selects the 7-HEX constellation point 2B with the lowest PAPR from among available 7-HEX constellation points for the second 4-QAM constellation point. Thus, the symbol mapper 205 maps the second 4-QAM modulation symbol to the 7-HEX constellation point, 2B. The PAPR of the transmission signal can be measured after IFFT. Therefore, while not shown, the symbol selector 207 includes an IFFT processor for measuring the PAPR.

Another embodiment of the present invention can be contemplated, in which the symbol selector 207 can select HEX constellation points for PAPR reduction by measuring the PAPR of a signal fed back from the IFFT processor 211.

The subcarrier mapper 209 maps the HEX modulation symbols received from the symbol mapper 205 to subcarriers according to a control signal received from an upper layer.

The IFFT processor 211 converts the frequency signal received from the subcarrier mapper 209 to a time signal by IFFT. The CP adder 213 adds a CP to the IFFT signal received from the IFFT processor 211. The RF processor 215 upconverts the baseband signal received from the CP inserter 213 to an RF signal transmittable in an actual frequency band and transmits the RF signal through an antenna.

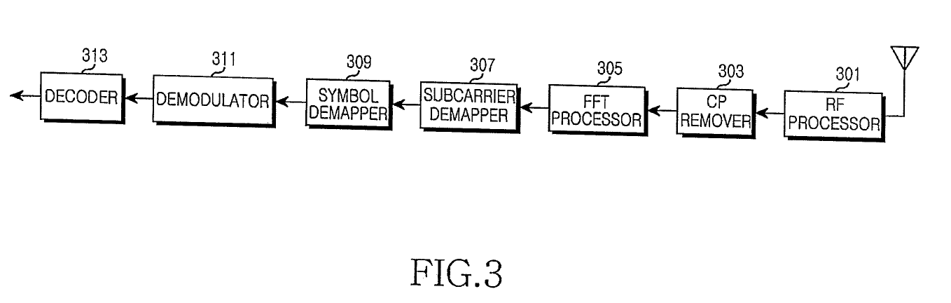

FIG. 3 is a block diagram of a receiver in the wireless communication system according to the present invention.

Referring to FIG. 3, the receiver includes an RF processor 301, a CP remover 303, a Fast Fourier Transform (FFT) processor 305, a subcarrier demapper 307, a symbol demapper 309, a demodulator 311, and a decoder 313.

The RF processor 301 downconverts an RF signal received through an antenna to a baseband signal. The CP remover 303 removes a CP from the baseband signal.

The FFT processor 305 converts the time signal received from the CP remover 303 to a frequency signal by FFT.

The subcarrier demapper 307 extracts actual data (i.e. modulation symbols) mapped to subcarriers from the FFT signals received from the FFT processor 305.

The symbol demapper 309 extracts modulation symbols, which were input to the symbol mapper 205 of the transmitter before symbol mapping, from the modulation symbols received from the subcarrier demapper 307. That is, the symbol demapper 309 extracts QAM modulation symbols from HEX modulation symbols received from the subcarrier demapper 307. If a modulation symbol received from the subcarrier demapper 307 is the HEX constellation point, 2B, the symbol demapper 309 extracts the second QAM modulation symbol mapped to the HEX constellation point, 2B.

The demodulator 311 demodulates the modulation symbols received from the symbol demapper 309 in accordance with a predetermined modulation scheme (e.g. MCS level). The decoder 313 decodes the demodulated data in accordance with a predetermined coding scheme (e.g. MCS level), thereby recovering original information data.

In the above-described embodiment of the present invention, the transmitter corresponds each QAM modulation symbol to one or more HEX constellation points, selects one of the one or more HEX constellation points, and maps the each QAM modulation symbol to the selected HEX constellation point.

It can be further contemplated as another embodiment that the transmitter corresponds each transmission symbol to one or more HEX constellation points, selects one of the one or more HEX constellation points, and maps the each transmission symbol to the selected HEX constellation point. Thus, the transmitter achieves PAPR reduction as well as modulates a transmission signal directly in a HEX modulation scheme without performing QAM modulation. Since one or more HEX constellation points are available for one transmission symbol, a HEX constellation point with a lower PAPR is selected from them and the transmission symbol is mapped to the selected HEX constellation point.

Now a description will be made of a method for reducing PAPR by use of a HEX modulation scheme.

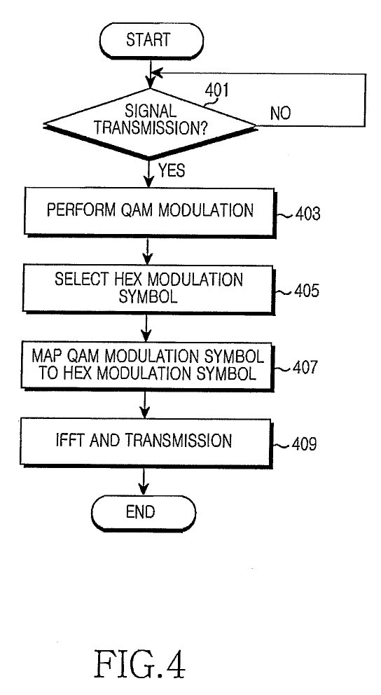

FIG. 4 is a flowchart illustrating a transmission operation for PAPR reduction according to an embodiment of the present invention.

Referring to FIG. 4, the transmitter monitors the presence of a transmission signal to be transmitted to the receiver in step 401.

In the presence of the transmission signal, the transmitter modulates the transmission signal in a predetermined modulation scheme (e.g. MCS level), for example, in QAM in step 403.

In step 405, the transmitter selects HEX constellation points with the lowest PAPR from among HEX constellation points available for the QAM modulation symbols. For example, if one or more HEX constellation points are available for each 4-QAM constellation point as illustrated in FIGS. 1A and 1B, the transmitter selects 7-HEX constellation points with the lowest PAPR from among the available 7-HEX constellation points and maps the 4-QAM modulation symbols to the selected 7-HEX constellation points.

After selecting the HEX constellation points, the transmitter maps the QAM modulation symbols to the selected HEX constellation points in step 407.

In step 409, the transmitter maps the HEX modulation symbols to subcarriers and transmits the mapped signals to the receiver after IFFT.

Then, the transmitter ends the algorithm of the present invention.

In the above-described embodiment of the present invention, the transmitter maps QAM modulation symbols to HEX constellation points, to thereby reduce PAPR. It can be further contemplated as another embodiment that the transmitter maps one transmission symbol to one HEX constellation point selected from among one or more HEX constellation points available for the transmission symbol. Thus the transmitter can reduce PAPR without QAM modulation. Since one or more HEX constellation points correspond to one transmission symbol, a HEX constellation point with a lower PAPR is selected from them and the transmission symbol is mapped to the selected HEX constellation point.

That is, for QAM constellation points, the symbol selector 207 selects HEX constellation points with the lowest PAPR from among HEX constellation points available for the QAM constellation points.

Specifically, the symbol selector 207 generates all possible combinations of the HEX constellation points available for the QAM modulation symbols, calculates the PAPRs of the combinations that can be obtained when the QAM modulation symbols are mapped to the HEX constellation points of the combinations, and selects a combination with the lowest PAPR for mapping to the QAM modulation symbols. For example, if 4-QAM modulation symbols are mapped to 7-HEX constellation points, the transmitter maps a first 4-QAM constellation point to a first 7-HEX constellation point. Then the transmitter correspond second, third and fourth 4-QAM modulation symbols to 7-HEX constellation points 2A and 2B, 3A and 3B, and 4A and 4B, respectively and produces all possible combinations of the 7-HEX constellation points 2A and 2B, 3A and 3B, and 4A and 4B. Then, the symbol selector 207 calculates the PAPRs of the combinations and maps the second, third and fourth 4-QAM modulation symbols to the 7-HEX constellation points of a combination with the lowest PAPR.

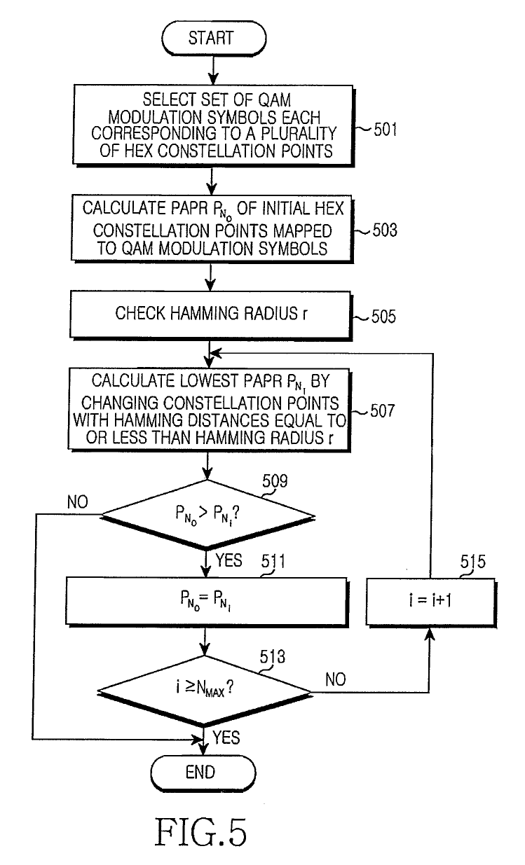

As illustrated in FIG. 5, the symbol selector 207 may detect constellation points that offer the lowest PAPR by repeatedly changing constellation points for mapping to modulation symbols a predetermined number of times.

FIG. 5 is a flowchart illustrating an operation for detecting HEX modulation symbols for PAPR reduction according to an embodiment of the present invention.

Referring to FIG. 5, the symbol selector 207 selects a set of QAM modulation symbols each of which can correspond to two or more HEX constellation points from among QAM modulation symbols in step 501.

In step 503, the symbol selector 207 calculates the PAPR PNO of initial values of HEX constellation points to be mapped to the selected set of QAM modulation symbols (hereinafter, referred to as initial HEX constellation points). For example, when each of 4-QAM modulation symbols corresponds to one or more 7-HEX constellation points as illustrated in FIGS. 1A and 1B, the symbol selector 207 sets initial 7-HEX constellation points to 1, 2A, 3A and 4A. Then the symbol selector 207 calculates the PAPR P_{N}_{₀} of a transmission signal composed of the initial HEX constellation points.

The symbol selector 207 checks a predetermined Hamming radius, r in step 505. The Hamming radius r indicates the number of constellation points that can be changed at one time in the transmission signal composed of the initial HEX constellation points. For example, if the Hamming radius r is 2, the symbol selector 207 can change up to two of the initial HEX constellation points at one time.

In step 507, the symbol selector 207 changes all HEX constellation points with Hamming distances equal to or less than the Hamming radius r in the initial HEX constellation points. Then the symbol selector 207 calculates the PAPRs of transmission signals including the changed HEX constellation points and selects the lowest PAPR P_{N}_{ᵢ}. For example, when the initial HEX constellation points are 1, 2A, 3A and 4A, the symbol selector 207 selects HEX constellation points with the lowest PAPR by changing HEX constellation points with Hamming distances equal to or less than the Hamming radius r in the initial HEX constellation points.

In step 509, the symbol selector 207 compares P_{N}_{₀} with P_{N}_{ᵢ}. i is a variable indicating the number of repetitions of a constellation point change. An initial value of i is 1.

If P_{N}_{ᵢ} is equal to or higher than P_{N}_{₀} (P_{N}_{₀}≦P_{N}_{₁}) in step 509, the symbol selector 207 selects the initial HEX constellation points to be mapped to the QAM modulation symbols.

Then, the symbol selector 207 ends the algorithm of the present invention.

On the other hand, if P_{N}_{ᵢ} is lower than P_{N}_{₀} (P_{N}_{₀}>P_{N}_{ᵢ}) in step 509, the symbol selector 207 sets P_{N}_{₀} to P_{N}_{ᵢ} in step 511. In step 513, the symbol selector 207 compares i with a maximum repetition number N_{MAX}.

If i is less than N_{MAX} (i<N_{MAX}), the symbol selector 207 increases by 1 in step 515. The symbol selector 207 returns to step 507 in which it changes HEX constellation points with Hamming distances equal to or less than Hamming radius r in the HEX constellation points with P_{N}_{₀} and obtains the lowest P_{N}_{ᵢ} of the PAPRs of transmission signals including the changed HEX constellation points.

If i equal to or larger than N_{MAX} (i≧N_{MAX}), the symbol selector 207 selects the HEX constellation points with P_{N}_{ᵢ} for mapping to the QAM modulation symbols.

Then, the symbol selector 207 ends the algorithm of the present invention.

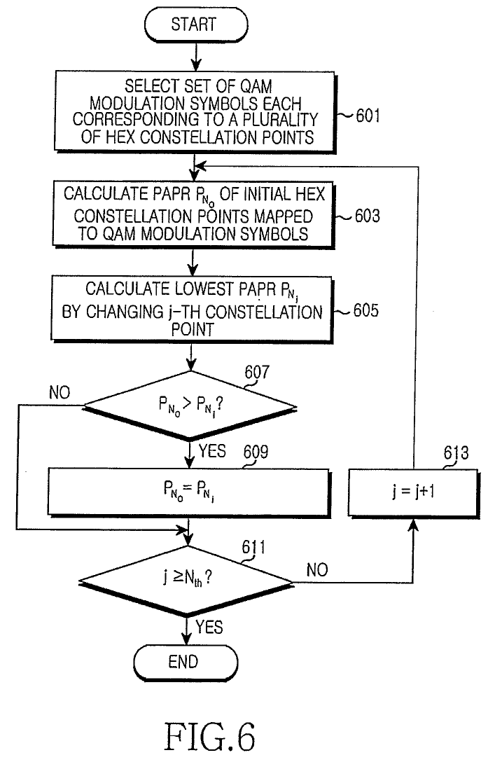

As illustrated in FIG. 6, the symbol selector 207 can select HEX constellation points with the lowest PAPR by sequentially changing the QAM modulation symbols.

FIG. 6 is a flowchart illustrating an operation for detecting HEX modulation symbols for PAPR reduction according to another embodiment of the present invention.

Referring to FIG. 6, the symbol selector 207 selects a set of QAM modulation symbols each of which can correspond to two or more HEX constellation points from among QAM modulation symbols in step 501.

In step 603, the symbol selector 207 calculates the PAPR P_{N}_{₀} of initial values of HEX constellation points to be mapped to the selected set of QAM modulation symbols (hereinafter, referred to as initial HEX constellation points). For example, when each of 4-QAM modulation symbols corresponds to one or more 7-HEX constellation points as illustrated in FIGS. 1A and 1B, the symbol selector 207 sets initial 7-HEX constellation points to 1, 2A, 3A and 4A. Then the symbol selector 207 calculates the PAPR P_{N}_{₀} of a transmission signal composed of the initial HEX constellation points.

In step 605, the symbol selector 207 changes a HEX constellation point for a j^{th} modulation symbol to other HEX constellation points in the initial HEX constellation points. Then the symbol selector 207 calculates the. PAPRs of transmission signals including the changed HEX constellation points, and selects the lowest PAPR P_{N}_{ⱼ}. For example, if a j^{th} QAM modulation symbol corresponds to HEX constellation points 2A and 2B and the initial value of a HEX constellation point for the j^{th} QAM modulation symbol is 2A, the HEX constellation point 2A is replaced with the HEX constellation point 2B. Then the PAPR of a transmission signal including the HEX constellation point 2B is calculated. If the j^{th} QAM modulation symbol corresponds to HEX constellation points 2A, 2B, 2C and the initial value of a HEX constellation point for the j^{th} QAM modulation symbol is 2A, the HEX constellation point 2A is replaced with the HEX constellation point 2B and then the HEX constellation point 2C. Then the PAPRs of transmission signals including the HEX constellation points 2B and 2C respectively are calculated and the symbol selector 207 selects the lowest PAPR. Here, j is the index of a modulation symbol and its initial value is 1.

In step 607, the symbol selector 207 compares P_{N}_{₀} with P_{N}_{ᵢ},

If P_{N}_{ⱼ} is equal to or higher than P_{N}_{₀} (P_{N}_{₀}≦P_{N}_{ⱼ}) in step 607, the symbol selector 207 determines whether all HEX constellation points to be mapped to the QAM modulation symbols have been selected by comparing j with the number N^{th} of the HEX constellation points to be mapped to the QAM modulation symbols in step 611.

On the other hand, if P_{N}_{ⱼ} is lower than P_{N}_{₀}(P_{N}_{₀}>P_{N}_{ⱼ}) in step 607 the symbol selector 207 sets P_{N}_{₀} to P_{N}_{ⱼ} in step 609 and goes to step 611.

If there remain HEX constellation points to be selected for mapping to the QAM modulation symbols (j<Nₜₕ), the symbol selector 207 increases j by 1 in step 613 and returns to step 605 in which it changes the HEX constellation point for the j^{th} modulation symbol and calculates the lowest PAPR P_{N}_{ⱼ}.

If all HEX constellation points are selected for the QAM modulation symbols (j≧Nₜₕ), the symbol selector 207 selects the HEX constellation points with P_{N}_{ⱼ}, for mapping to the QAM modulation symbols.

Then, the symbol selector 207 ends the algorithm of the present invention.

A description will be made of an operation of the receiver for receiving a signal with a decreased PAPR transmitted in the procedure illustrated in FIG. 4.

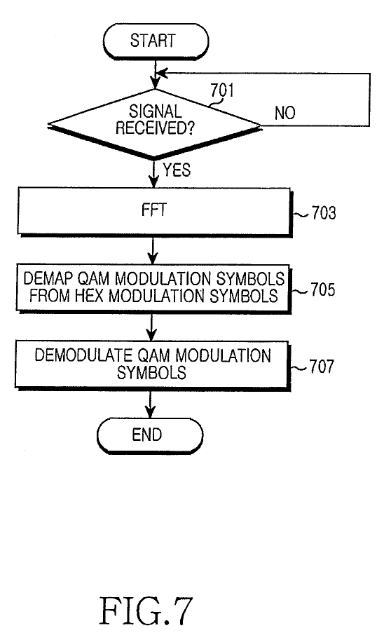

FIG. 7 is a flowchart illustrating a reception operation for PAPR reduction according to an embodiment of the present invention.

Referring to FIG. 7, the receiver monitors reception of a signal from the transmitter in step 701. Upon receipt of the signal, the receiver extracts modulation symbols from subcarriers by FFT-processing the signal in step 703.

In step 705, the receiver extracts modulation symbols, which were input o the symbol mapper 205 of the transmitter before symbol mapping, from the modulation symbols extracted from subcarriers. That is, the receiver extracts QAM modulation symbols from HEX modulation symbols extracted from subcarriers. For example, if the extracted HEX modulation symbol is a constellation point 2B, the receiver extracts a second QAM modulation symbol mapped to the constellation point 2B.

In step 707, the receiver demodulates the QAM modulation symbols. Then, the receiver ends the algorithm of the present invention.

In the above embodiment of the present invention, a minimum distance between HEX constellation points is equal to the distance between QAM constellation points in the wireless communication system. As a result, the HEX modulation scheme has more adjacent constellation points than the QAM modulation scheme. This means that HEX may suffer from performance degradation in terms of symbol errors, compared to QAM.

Accordingly, the wireless communication system can change the minimum distance between HEX constellation points by

$${d}_{HEX} = \sqrt{\frac{{P}_{QAM}}{{P}_{HEX}}} \cdot d \qquad ( 5 )$$

where d_{HEX} denotes the minimum distance between HEX constellation points, P_{QAM} denotes the average power of a QAM signal (QAM average power), P_{HEX} denotes the average power of a HEX signal (HEX average power), and d denotes an original minimum distance between HEX constellation points.

As noted from Equation (5), the minimum distance between HEX constellation points can be increased or decreased by the ratio between the QAM average power and the HEX average power.

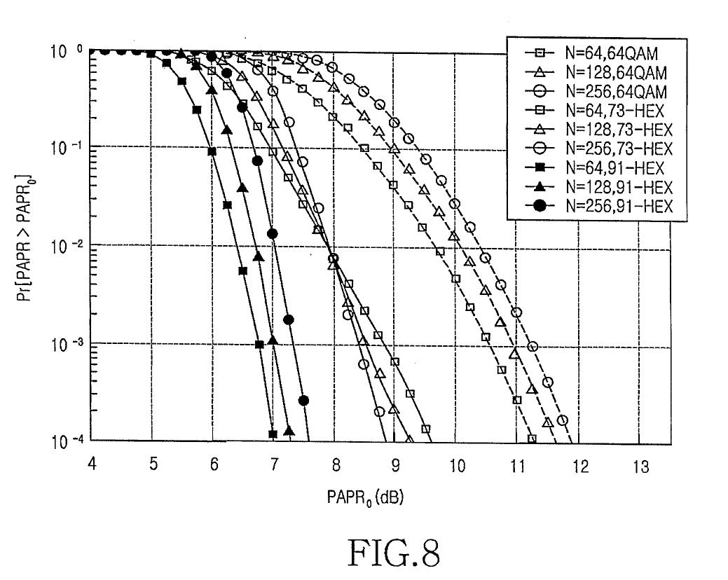

FIG. 8 is a graph illustrating PAPR reduction according to an embodiment of the present invention. The horizontal axis represents PAPR threshold and the vertical axis represents probability of the PAPR of an OFDM block being higher than the PAPR threshold. It is assumed herein that the transmitter selects HEX constellation points to be mapped to QAM modulation symbols by sequentially changing HEX constellation points corresponding to the QAM modulation symbols in the method illustrated in FIG. 6.

Referring to FIG. 8, the PAPR of a 64-QAM signal is compared with the PAPRs of a 73-HEX signal and a 91-HEX signal to which 64-QAM signals are mapped, for 64, 128, and 256 subcarriers, respectively.

In the case where 64-QAM constellation points are mapped to 73-HEX constellation points, the wireless communication system designs the 73-HEX constellation points such that 55 64-QAM constellation points correspond to 55 73-HEX constellation points in a one-to-one fashion and each of the remaining 9 64-QAM constellation points corresponds to a plurality of 73-HEX constellation points.

In the case where 64-QAM constellation points are mapped to 91-HEX constellation points, the wireless communication system designs the 91-HEX constellation points such that 33 64-QAM constellation points correspond to 373-HEX constellation points in a one-to-one fashion and each of the remaining 27 64-QAM constellation points corresponds to a plurality of 91-HEX constellation points.

As noted from the graph, a 64-QAM signal has a PAPR of 10.6 dB for 64 subcarriers, 10.9 dB for 128 subcarriers, and 11.2 dB for 256 subcarriers in OFDM blocks with a probability of 0.1 or less.

When each of 64 QAM constellation points corresponds to one or more 73-HEX constellation points, a 73-HEX signal has a PAPR of 8.4 dB for 64 subcarriers, 8.5 dB for 128 subcarriers, and 8.7 dB for 256 subcarriers OFDM blocks with a probability of 0.1 or less.

When each of 64 QAM constellation points corresponds to one or more 91-HEX constellation points, a 91-HEX signal has a PAPR of 6.7 dB for 64 subcarriers, 7.0 dB for 128 subcarriers, and 7.3 dB for 256 subcarriers in OFDM blocks with a probability of 0.1 or less.

Therefore, it is concluded that the mapping from 64-QAM modulation symbols to HEX constellation points leads to a PAPR decrease in a transmission signal.

As is apparent from the above description, the present invention advantageously reduces PAPR without increasing average power by mapping QAM modulation symbols to HEX constellation points, prior to transmission in a wireless communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A transmitter in an Orthogonal Frequency Division Multiplexing (OFDM) wireless communication system, comprising:
an encoder for encoding a transmission signal in a predetermined coding scheme
a modulator for modulating the encoded transmission signal, the encoded transmission signal mapping to each symbol of a HEXagonal (HEX) constellation point in a HEX modulation scheme, wherein the each symbol selected from at least one available symbol of HEX constellation point;
a processor for applying a fourier transform to the modulated transmission signal to bring the transmission signal into the time domain for transmission; and
a Radio Frequency (RF) processor for upconverting the multiplexed information for transmission.

2. The transmitter of claim 1, wherein the processor for applying an inverse Fourier transform to the modulated transmission signal.

3. The transmitter of claim 1, wherein the Radio Frequency(RF) processor for upconverting a baseband signal received from a Cyclic Prefix (CP) to an RF signal transmittable in an actual frequency band and transmits the RF signal through an antenna

4. The transmitter of claim 1, wherein the modulator comprises a symbol selector for selecting HEX constellation points with a lowest PAPR for symbols of the coded transmission signal from among HEX constellation points available for mapping to the symbols, and modulates the coded transmission signal by mapping the symbols to the selected HEX constellation points.

5. The transmitter of claim 4, wherein the symbol selector selects a combination of HEX constellation points with a lowest PAPR from among all combinations of the HEX constellation points available for mapping to the symbols, at least one HEX constellation point being available for mapping to each symbol.

6. The transmitter of claim 4, wherein the symbol selector sequentially selects one of the symbols and selects a HEX constellation point with a lowest PAPR from among at least one HEX constellation point available for the selected symbol.

7. The transmitter of claim 4, wherein the symbol selector checks the number of symbols changeable at one time among the symbols, and selects a combination of HEX constellation points with a lowest PAPR from among combinations of HEX constellation points available for the number of symbols changeable at one time, at least one HEX constellation point being available for mapping to each of the symbols.

8. The transmitter of claim 7, wherein the symbol selector determines the number of symbols changeable at one time according to a Hamming radius.

9. A transmission method in an Orthogonal Frequency Division Multiplexing (OFDM) wireless communication system, comprising:
encoding a transmission signal in a predetermined coding scheme
modulating the coded transmission signal by mapping each symbol of a HEXagonal (HEX) constellation point in a HEX modulation scheme wherein the each symbol selected from at least one available symbol of HEX constellation point;
applying a fourier transform to the modulated transmission signal to bring the transmission signal into a time signal by fourier transform; and
upconverting the multiplexed in from time signal to a Radio Frequency (RF) signal and transmitting the RF signal to a receiver through an antenna.

10. The transmission method of claim 9, wherein the coding scheme is determined according to a Modulation and Coding Scheme (MCS) level.

11. The transmission method of claim 9, wherein the modulation comprises:
selecting HEX constellation points with a lowest PAPR for symbols of the coded transmission signal from among HEX constellation points available for mapping to the symbols; and
mapping the symbols to the selected HEX constellation points.

12. The transmission method of claim 11, wherein the HEX constellation point selection comprises:
creating all combinations of the HEX constellation points available for mapping to the symbols, at least one HEX constellation point being available for mapping to each symbol;
calculating the PAPRs of the combinations that can be obtained when the symbols of the coded transmission signal are mapped to the combinations; and
selecting a combination of HEX constellation points with a lowest of the APRs.

13. The transmission method of claim 11, wherein the HEX constellation point selection comprises:
sequentially selecting one of the symbols; and
selecting a HEX constellation point with a lowest PAPR from among at east one HEX constellation point available for the selected symbol.

14. The transmission method of claim 11, wherein the HEX constellation point selection comprises:
checking the number of symbols changeable at one time among the symbols; and
selecting a combination of HEX constellation points with a lowest PAPR from among combinations of HEX constellation points available for the number of symbols changeable at one time, at least one HEX constellation point being available for mapping to each of the symbols.

15. The transmission method of claim 14, wherein the number of symbols changeable at one time among the symbols is determined according to a Hamming radius.

16. A transmitter in an Orthogonal Frequency Division Multiplexing (OFDM) wireless communication system, comprising:
an encoder for encoding a transmission signal in a predetermined coding scheme and outputting a coded transmission signal;
a modulator for modulating the coded transmission signal in a Quadrature Amplitude Modulation (QAM) modulation scheme and outputting QAM modulation symbols;
a symbol mapper for mapping each of the QAM modulation symbols to a HEXagonal (HEX) constellation point being a constellation point of a HEX modulation scheme selected from at least one HEX constellation point available for mapping to the each QAM modulation symbol and outputting a mapped transmission signal;
an Inverse Fast Fourier Transform (IFFT) processor for converting the mapped transmission signal to a time signal by IFFT; and
a Radio Frequency (RF) processor for converting the time signal to an RF signal and transmitting the RF signal to a receiver through an antenna.

17. The transmitter of claim 16, wherein a distance between HEX constellation points is at least equal to a distance between QAM constellation points and the HEX modulation scheme has more constellation points than the QAM modulation scheme in the same area.

18. The transmitter of claim 16, wherein the symbol mapper comprises a symbol selector for selecting HEX constellation points with a lowest PAPR for the QAM modulation symbols from among HEX constellation points available for mapping to the QAM modulation symbols, and maps the QAM modulation symbols to the selected HEX constellation points.

19. The transmitter of claim 18, wherein the symbol selector selects a combination of HEX constellation points with a lowest PAPR from among all combinations of the HEX constellation points available for mapping to the QAM modulation symbols, at least one HEX constellation point being available for mapping to each QAM modulation symbol.

20. The transmitter of claim 18, wherein the symbol selector sequentially selects one of the QAM modulation symbols and selects a HEX constellation point with a lowest PAPR from among at least one HEX constellation point available for the selected QAM modulation symbol.

21. The transmitter of claim 18, wherein the symbol selector checks the number of QAM modulation symbols changeable at one time among the QAM modulation symbols, and selects a combination of HEX constellation points with a lowest PAPR from among combinations of HEX constellation points available for the number of QAM modulation symbols changeable at one time, at least one HEX constellation point being available for mapping to each of the QAM modulation symbols.
